(19) United States
(12) Patent Application Publication
(10) Pub. No.: US 2020/0339075 A1
(43) Pub. Date: Oct. 29, 2020

(54) MANUAL RELEASE MECHANISM FOR VEHICLE PARKING LOCK DEVICE

(71) Applicant: TOYOTA JIDOSHA KABUSHIKI KAISHA, Toyota-shi (JP)

(72) Inventors: Kazunori KANEKO, Toyota-shi (JP); Eiji ITO, Nisshin-shi (JP); Kiyonori TAKAGI, Okazaki-shi (JP); Hiroshi KAWANISHI, Nisshin-shi (JP); Soma NAKAGAMI, Toyota-shi (JP)

(73) Assignee: TOYOTA JIDOSHA KABUSHIKI KAISHA, Toyota-shi (JP)

(21) Appl. No.: 16/835,604

(22) Filed: Mar. 31, 2020

(30) Foreign Application Priority Data
Apr. 26, 2019 (JP) 2019-086755

(51) Int. Cl. B60T 1/00

(52) U.S. Cl. CPC B60T 1/005

(57) ABSTRACT

Provided is a manual release mechanism for a parking lock device including a gear, a meshing tooth capable of meshing with the gear, and an actuator that switches between a parking lock state and a non-parking lock state. The manual release mechanism includes an outer lever, an elastic member, and a retaining member. An activation state of the parking lock device is switched by the outer lever. One end of the elastic member is mounted on the outer lever. The retaining member has the other end of the elastic member mounted thereon, and retains the outer lever in a turning position through the elastic member. The elastic member is mounted between the outer lever and the retaining member so as to exert a force in the direction of a tangent to a turning locus of the outer lever when the outer lever is not being manually operated by the driver.

### CROSS-REFERENCE TO RELATED APPLICATIONS

This application claims priority to Japanese Patent Application No. 2019-086755 filed on Apr. 26, 2019 incorporated herein by reference in its entirety.

### BACKGROUND

### 1. Technical Field

The present disclosure relates to a manual release mechanism that allows a vehicle parking lock device to be manually released.

### 2. Description of Related Art

Some vehicles are known to be equipped with a manual release mechanism that allows a vehicle parking lock device provided in the vehicle to be manually released. Such a manual release mechanism is described in Japanese Patent Application Publication No. 2017-32119 (JP 2017-32119 A). JP 2017-32119 A discloses a manual release mechanism including: a lever member that can be turned to switch a parking lock device between a lock state and an unlock state; an operating force transmission member that is coupled to the lever member and transmits a driver's operation to the lever member; a support member that supports the operating force transmission member; and an urging member that is disposed between the support member and the lever member coaxially with the operating force transmission member and urges the lever member in the opposite direction from a shifting direction of the operating force transmission member.

### SUMMARY

When the operating force transmission member (a cable etc.) of the manual release mechanism of JP 2017-32119 A is removed to convert the lever member (hereinafter referred to as an outer lever) to a type that is directly released by manual operation, the outer lever shakes during travel of the vehicle, which may result in generation of noise associated with shaking of the outer lever and degradation of the durability of the outer lever due to repeated shaking.

Having been contrived under these circumstances, the present disclosure provides a structure that can, in a vehicle equipped with a manual release mechanism that allows a vehicle parking lock device to be manually released, restrain an outer lever from shaking during travel of the vehicle and thereby mitigate generation of noise and degradation of the durability of the outer lever.

An aspect of the present disclosure relates to a manual release mechanism for a vehicle parking lock device. The parking lock device includes: a gear mechanically coupled to a driving wheel; a meshing tooth capable of meshing with the gear; and an actuator configured to switch between a parking lock state where the meshing tooth and the gear are in mesh and a non-parking lock state where the meshing tooth and the gear are out of mesh. The parking lock device is configured to manually operated by a driver to switch between the parking lock state and the non-parking lock state through the actuator. The manual release mechanism includes an outer lever, an elastic member, and a retaining member. The outer lever is configured to be turned by manual operation of the driver to switch an activation state of the parking lock device. One end of the elastic member is mounted on the outer lever. The retaining member includes the other end of the elastic member mounted thereon, and is configured to retain the outer lever in a turning position through the elastic member. The elastic member is mounted between the outer lever and the retaining member so as to exert a force in the direction of a tangent to a turning locus of the outer lever when the outer lever is not being manually operated by the driver.

In the manual release mechanism of this aspect, since the elastic member is mounted between the outer lever and the retaining member so as to exert a force in the direction of the tangent to the turning locus of the outer lever, the outer lever is retained by the elastic member with a greater retaining force and restrained from shaking during travel of the vehicle. Thus, generation of noise due to shaking of the outer lever and degradation of the durability of the outer lever can be mitigated. When the outer lever is manually operated, the angle formed between the tangent to the turning locus of the outer lever and a straight line parallel to the direction in which the elastic member exerts a force increases as the outer lever is turned, so that the amount of increase in an operating force required to turn the outer lever is reduced.

In the manual release mechanism of the above aspect, the outer lever may have an elongated shape and be configured to be able to turn around a turning center portion that is provided at a predetermined position in the outer lever in a longitudinal direction of the outer lever. The outer lever may include a lever part that is manually operated by the driver and a hook part on which the one end of the elastic member is mounted, with the turning center portion of the outer lever located on a border between the lever part and the hook part. The outer lever may be provided such that an angle formed by the intersection of a first straight line and a second straight line is larger than 90 degrees. The first straight line is parallel to a longitudinal direction of the lever part and passes through the center of the turning center portion. The second straight line is parallel to a longitudinal direction of the hook part and passes through the center of the turning center portion.

In the manual release mechanism having this configuration, the outer lever is formed such that the angle formed by the intersection of the first straight line that is parallel to the longitudinal direction of the lever part and passes through the center of the turning center portion and the second straight line that is parallel to the longitudinal direction of the hook part and passes through the center of the turning center portion is larger than 90 degrees. Thus, the center of gravity of the outer lever is set close to the turning center portion of the outer lever. As a result, the outer lever is less likely to shake, and restraining the outer lever from shaking requires a smaller retaining force.

The manual release mechanism of the above aspect may include a shaft interposed between the actuator and the meshing tooth. The turning center portion may be mechanically coupled to the shaft.

In the manual release mechanism having this configuration, the turning center portion is mechanically coupled to the shaft. Therefore, when the lever part is activated by manual operation of the driver, the turning center portion of the manual release mechanism moves so as to activate the shaft. The meshing tooth and the gear can be thereby caused to mesh with each other or come out of mesh.

In the manual release mechanism of the above aspect, the hook part may be provided so as to be located above the turning center portion of the outer lever in a vertical direction in a state of the manual release mechanism being installed in a vehicle.

In the manual release mechanism having this configuration, since the hook part is provided so as to be located above the turning center portion of the outer lever in the vertical direction in the state of the manual release mechanism being installed in a vehicle, water and mud are less likely to get on the elastic member during travel of the vehicle.

In the manual release mechanism of the above aspect, the lever part may be provided so as to be located below the turning center portion of the outer lever in a vertical direction in a state of the manual release mechanism being installed in a vehicle.

In the manual release mechanism having this configuration, the lever part is easy to turn by manual operation from the lower side of the vehicle. Since the lever part is provided so as to be located below the turning center portion of the outer lever in the vertical direction in the state of the manual release mechanism being installed in a vehicle, the lever part is easy to turn by manual operation from the lower side of the vehicle.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is a skeleton diagram illustrating a schematic configuration of a hybrid vehicle to which the present disclosure is applied;

FIG. 2 is a view showing the structure of a parking lock device of FIG. 1;

FIG. 3 is a view of a part of a power transmission device as seen from a front side of the hybrid vehicle in a state of being installed in the hybrid vehicle, showing an area where a manual release mechanism is provided;

FIG. 4 is a view showing a relation between forces acting on an outer lever before the manual release mechanism of FIG. 3 is manually operated; and

FIG. 5 is a view showing a relation between the forces acting on the outer lever when the manual release mechanism of FIG. 3 is manually operated.

### DETAILED DESCRIPTION OF EMBODIMENTS

An embodiment of the present disclosure will be described in detail below with reference to the drawings. The drawings in the following embodiment are simplified or deformed as necessary, and the dimensional ratios, the shapes, etc. of parts are not necessarily accurately represented.

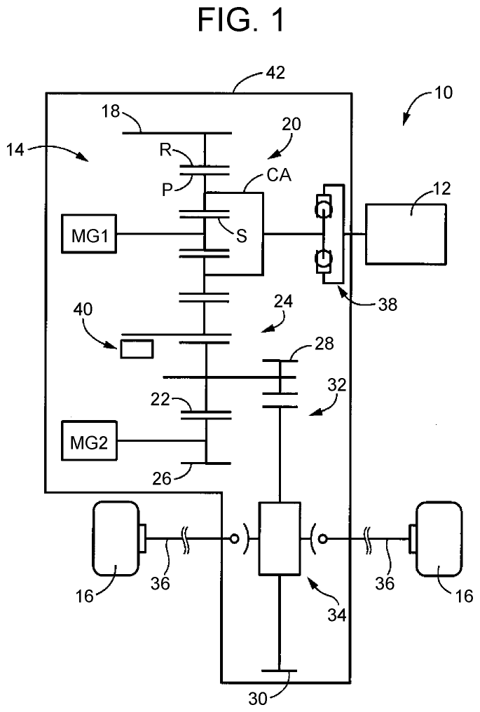

FIG. 1 is a skeleton diagram illustrating a schematic configuration of a hybrid vehicle 10 (hereinafter referred to as a vehicle 10) to which the present disclosure is applied. In FIG. 1, the vehicle 10 includes an engine 12 as a main driving source for traveling, and a power transmission device 14 that transmits power from the engine 12 to driving wheels 16.

The power transmission device 14 includes: a power distribution mechanism 20 that distributes power output from the engine 12 to a first motor MG1 and a counter drive gear 18 (hereinafter referred to as a drive gear 18); a counter gear pair 24 composed of the drive gear 18 and a counter driven gear 22 (hereinafter referred to as a driven gear 22) that meshes with the drive gear 18; a second motor MG2 coupled to the driven gear 22 through a reduction gear 26 so as to be able to transmit power; a final gear pair 32 composed of a differential drive gear 28 and a differential driven gear 30; a differential gear set 34 (differential gear device); and a pair of left and right axles 36. The driven gear 22 and the differential drive gear 28 are configured to rotate integrally. All these members are housed inside a case 42 of the power transmission device 14. The power transmission device 14 is suitably used for a front-engine, front-wheel-drive (FF) vehicle with the engine placed in transverse position of the vehicle.

In the power transmission device 14, power from the engine 12 is transmitted to the driven gear 22 through the power distribution mechanism 20 and the drive gear 18, while power from the second motor MG2 is transmitted to the driven gear 22 through the reduction gear 26, and the power is transmitted from the driven gear 22 to the pair of left and right driving wheels 16 sequentially through the final gear pair 32, the differential gear set 34, and the pair of left and right axles 36 (drive shafts). A damper device 38 that absorbs torque fluctuations is interposed between the engine 12 and the power distribution mechanism 20.

The power distribution mechanism 20 is formed by a commonly known planetary gear device of a single pinion gear type that includes, as rotating elements, a sun gear S, a pinion gear P, a carrier CA that supports the pinion gear P so as to be able to rotate and revolve, and a ring gear R that meshes with the sun gear S through the pinion gear P. The sun gear S is coupled to the first motor MG1 so as to be able to transmit power, and the carrier CA is coupled to the engine 12 so as to be able to transmit power. The ring gear R is coupled to the drive gear 18 so as to be able to transmit power. Thus, the sun gear S, the carrier CA, and the ring gear R can rotate relatively to one another and thereby distribute power from the engine 12 to the first motor MG1 and the drive gear 18. Moreover, the power distribution mechanism 20 is set in a state of continuously variable transmission (electric CVT), for example, and functions as an electric continuously variable transmission in which rotation of the ring gear R coupled to the drive gear 18 is continuously varied regardless of predetermined rotation of the engine 12. Thus, the power distribution mechanism 20 functions as an electric differential unit (electric continuously variable transmission unit) such that a differential state of the power distribution mechanism 20 is controlled as an operating state of the first motor MG1 functioning as a motor for a differential is controlled.

A vehicle parking lock device 40 (hereinafter referred to as a parking lock device 40) is provided alongside the drive gear 18. The parking lock device 40 is configured to be able to switch between a parking lock state corresponding to a P-range that is a parking range of the vehicle 10 and a non-parking lock state corresponding to a non-P-range, through an actuator 50 to be described later. The parking lock device 40 switches the vehicle 10 to the parking lock state by mechanically stopping the drive gear 18 from rotating. Since the drive gear 18 is mechanically coupled to the driving wheels 16 through the counter gear pair 24, the final gear pair 32, the differential gear set 34, and the left and right axles 36, the driving wheels 16 are stopped from rotating when the drive gear 18 is stopped from rotating.

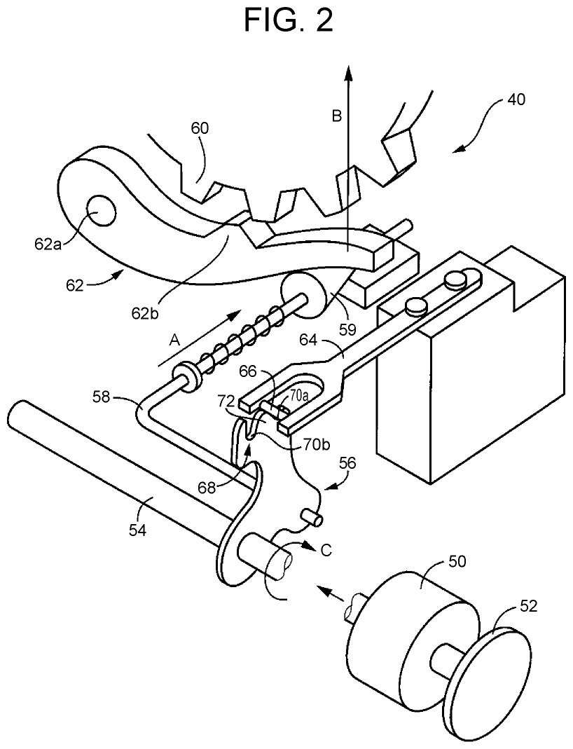

FIG. 2 shows the structure of the parking lock device 40 of FIG. 1. The parking lock device 40 includes: an actuator 50; a rotary encoder 52 that detects a rotation position of the actuator 50; a shaft 54 that is driven to rotate by the actuator 50; a detent plate 56 that is provided on the shaft 54 and rotates as the shaft 54 rotates; an L-shaped rod 58 that is activated as the detent plate 56 rotates; a conical tapered member 59 provided at a leading end of the rod 58; a parking gear 60 that is formed integrally with the drive gear 18 and thereby mechanically coupled to the driving wheels 16; a parking lock pawl 62 having a meshing tooth 62b capable of meshing with the parking gear 60; a detent spring 64 and a roller 66 that function as a retaining mechanism for retaining the detent plate 56 in a rotation position. The parking gear 60 is an example of the gear of the present disclosure.

The actuator 50 is formed by a switched reluctance motor (SR motor), and controls an activation state of the parking lock device 40 by receiving a command (control signal) from an electronic control device (not shown). The rotary encoder 52 outputs A-phase and B-phase signals. By rotating integrally with the actuator 50, the rotary encoder 52 detects a rotation status of the SR motor and outputs a signal indicating the rotation status, i.e., a pulse signal for acquiring a counter value (encoder count CP) according to the amount of rotation of the actuator 50, to the electronic control device. By acquiring the signal supplied from the rotary encoder 52, the electronic control device learns the rotation position of the actuator 50 and controls application of a current for driving the actuator 50.

The detent plate 56 is rotated by the actuator 50 through the shaft 54, and can rotate to a rotation position corresponding to the P-range in which the vehicle 10 is in the parking lock state and to a rotation position corresponding to the non-P-range in which the vehicle 10 is in the non-parking lock state.

The detent plate 56 is formed in a waved surface 68, and the roller 66 is pressed against the waved surface 68 by an urging force of the detent spring 64. The waved surface 68 is formed by two valleys, i.e. a first valley 70a and a second valley 70b, and a ridge 72 between the two varies i.e. the first valley 70a and the second valley 70b. A rotation position of the detent plate 56 in which the roller 66 is in contact with the first valley 70a of the detent plate 56 corresponds to the rotation position corresponding to the non-P-range. A rotation position of the detent plate 56 in which the roller 66 is in contact with the second valley 70b of the detent plate 56 corresponds to the rotation position corresponding to the P-range.

One end of the rod 58 is coupled to the detent plate 56. The tapered member 59 is provided at the other end of the rod 58. A side of the rod 58 at which the tapered member 59 is provided is moved in a longitudinal direction according to the rotation position of the detent plate 56. Therefore, the position of the tapered member 59 is changed according to the rotation position of the detent plate 56.

The parking lock pawl 62 is in contact with the tapered member 59. The parking lock pawl 62 has an elongated shape and is configured to be able to turn around a turning center portion 62a. The meshing tooth 62b capable of meshing with the parking gear 60 is formed on the parking lock pawl 62.

A side of the parking lock pawl 62 opposite from the turning center portion 62a in a longitudinal direction is in contact with the tapered member 59. As the portion of the tapered member 59 that is in contact with the parking lock pawl 62 is changed, the parking lock pawl 62 is turned around the turning center portion 62a.

For example, when the parking lock pawl 62 comes into contact with a small-diameter portion (leading end portion) of the tapered member 59, the parking lock pawl 62 is turned in a clockwise direction around the turning center portion 62a. Thus, the non-parking lock state where the parking gear 60 and the meshing tooth 62b are out of mesh as shown in FIG. 2 is created. The parking lock device 40 is set such that the roller 66 and the first valley 70a of the detent plate 56 come into contact with each other when the parking gear 60 and the meshing tooth 62b come out of mesh.

On the other hand, when the parking lock pawl 62 comes into contact with a large-diameter portion of the tapered member 59, the parking lock pawl 62 is turned in a counterclockwise direction around the turning center portion 62a. Thus, the parking lock state where the parking lock pawl 62 and the meshing tooth 62b are in mesh and the parking gear 60 is stopped from rotating is created. The parking lock device 40 is set such that the roller 66 and the second valley 70b of the detent plate 56 come into contact with each other when the parking gear 60 and the meshing tooth 62b mesh with each other.

FIG. 2 shows a state where the detent plate 65 has been rotated to the rotation position corresponding to the non-P-range in which the vehicle 10 is in the non-parking lock state. In this state, the shaft 54 is rotated toward the opposite side from arrow C shown in FIG. 2, and the leading end of the rod 58 at the side where the tapered member 59 is provided is moved toward the opposite side from arrow A of FIG. 2. Thus, the parking lock pawl 62 comes into contact with the small-diameter portion of the tapered member 59, so that the parking lock pawl 62 is rotated in the clockwise direction and the parking gear 60 and the meshing tooth 62b come out of mesh.

When the shaft 54 is rotated by the actuator 50 in the direction of arrow C shown in FIG. 2 from the state shown in FIG. 2, the rod 58 is moved in the direction of arrow A through the detent plate 56, and the parking lock pawl 62 is turned around the turning center portion 62a in the direction of arrow B by the tapered member 59 provided at the leading end of the rod 58. As a result, the parking gear 60 meshes with the meshing tooth 62b and the parking gear is stopped from rotating, which switches the travel range to the P-range in which the vehicle 10 is in the parking lock state. During a transition period of switching the travel range from the non-P-range to the P-range, the detent plate 56 is rotated and the roller 66 pressed against the waved surface 68 of the detent plate 56 crosses over the ridge 72 and moves toward the second valley 70b corresponding to the P-range, from the state of being in contact with the first valley 70a corresponding to the non-P-range. Then, the roller 66 is pressed against the second valley 70b corresponding to the P-range, so that the detent plate 56 is retained in the rotation position corresponding to the P-range.

For example, if the actuator 50 or the electronic control device that controls the actuator 50 fails with the travel range switched to the P-range, it becomes difficult to switch the travel range to the non-P-range and to move the vehicle 10. To respond to such a situation, a manual release mechanism 74 is provided that allows the activation state of the parking lock device 40 to be switched from an outside by manual operation of a driver even when the actuator 50 or the electronic control device has failed.

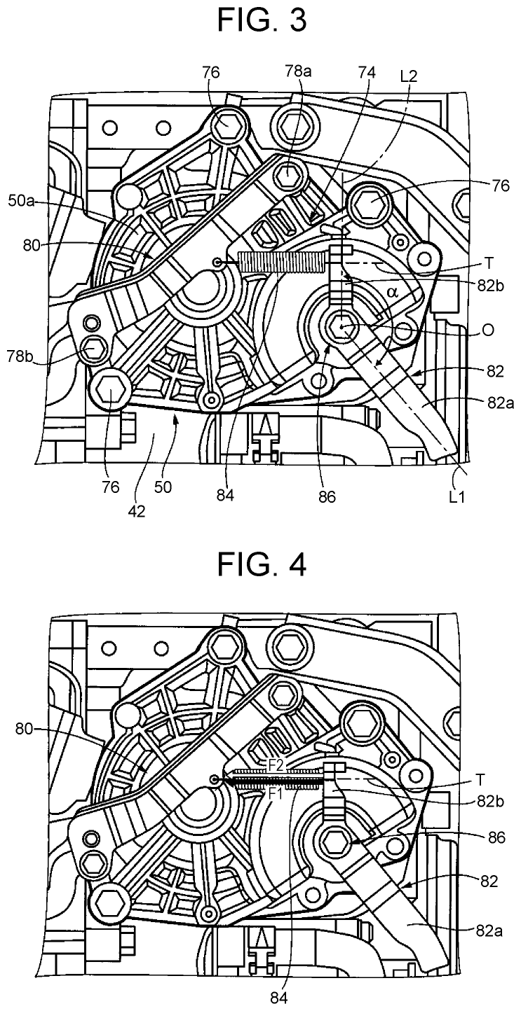

FIG. 3 is a view showing a part of the power transmission device 14 as seen from a front side of the vehicle 10 in a state of being installed in the vehicle, showing an area where the manual release mechanism 74 is provided. An up-down direction and a left-right direction in the sheet of FIG. 3 correspond to a vertical direction and a vehicle width direction of the vehicle 10, respectively. FIG. 3 shows a state where the vehicle 10 is on a flat road surface.

In FIG. 3, the area enclosed by the thick solid line corresponds to the actuator 50 of the parking lock device 40. As shown in FIG. 3, the actuator 50 is mounted with a plurality of bolts 76 on the case 42 of the power transmission device 14 that is located in a front part of the vehicle 10 in a state of being installed in the vehicle. A case member 50a of the actuator 50 is shown in FIG. 3, and a motor etc. of the actuator 50 are housed inside the case member 50a. The actuator 50 is mechanically connected to the shaft 54 housed inside the case 42.

The manual release mechanism 74 is provided on the case member 50a of the actuator 50. The manual release mechanism 74 includes a retaining member 80 that is fixed to the case member 50a with a pair of bolts 78a, 78b, an outer lever 82 that is turned by manual operation of the driver, and a coil spring 84 that is provided between the retaining member 80 and the outer lever 82. One end of the coil spring 84 is mounted on the outer lever 82 and the other end thereof is mounted on the retaining member 80. The coil spring 84 is an example of the elastic member of the present disclosure.

The retaining member 80 is a member that retains the outer lever 82 in a turning position through the coil spring 84. The retaining member 80 is a metal member having an elongated shape, and both ends of the retaining member 80 in a longitudinal direction are fixed to the case member 50a of the actuator 50 with the bolts 78a, 78b. The other end of the coil spring 84 is mounted near a middle portion of the retaining member 80 in the longitudinal direction.

By being disposed so as to cover the actuator 50 as shown in FIG. 3, the retaining member 80 functions as a protective member that protects the actuator 50 in the event of a collision of the vehicle 10. Moreover, by having both ends fixed to the case member 50a of the actuator 50, the retaining member 80 forms part of the case member 50a of the actuator 50 and enhances the rigidity of the actuator 50. Thus, the retaining member 80 functions also to reduce noise due to resonance of the actuator 50. In addition, since the retaining member 80 is fixed to the case member 50a of the actuator 50, the retaining member 80 can be installed at the same time when the actuator 50 is installed.

The outer lever 82 is a metal member formed in an elongated shape, and is bent at a predetermined portion in a longitudinal direction. A turning center portion 86 is provided at the bent portion of the outer lever 82, and the outer lever 82 is configured to be able to turn around the turning center portion 86. The turning center portion 86 is mechanically coupled to the shaft 54 of the parking lock device 40, and turning the turning center portion 86 causes the shaft 54 to turn and thereby switches the activation state of the parking lock device 40. Thus, the activation state of the parking lock device 40 is switched as the outer lever 82 is turned by manual operation of the driver.

The outer lever 82 is composed of a lever part 82a that is manually operated by the driver and a hook part 82b on which the one end of the coil spring 84 is mounted, with the turning center portion 86 of the outer lever 82 located on a border between the lever part 82a and the hook part 82b. The lever part 82a and the hook part 82b are integrally molded so as to move in conjunction with each other. The length of the lever part 82a in a longitudinal direction is longer than the length of the hook part 82b in a longitudinal direction.

As shown in FIG. 3, the lever part 82a of the outer lever 82 is provided so as to be located below the turning center portion 86 of the outer lever 82 in the vertical direction in a state of the manual release mechanism 74 being installed in the vehicle. Thus, the lever part 82a is easy to turn by manual operation from a lower side of the vehicle 10. The hook part 82b of the outer lever 82 is provided so as to be located above the turning center portion 86 in the vertical direction in the state of the manual release mechanism 74 being installed in the vehicle. Thus, water and mud are less likely to get on the coil spring 84 during travel of the vehicle.

As shown in FIG. 3, the outer lever 82 is parallel to the longitudinal direction of the lever part 82a and is formed such that an angle a formed by the intersection of a first straight line L1 and a second straight line L2 is larger than 90 degrees. The first straight line L1 is a straight line that is parallel to the longitudinal direction of the lever part 82a and passes through a center O of the turning center portion 86. The second straight line L2 is a straight line that is parallel to the longitudinal direction of the hook part 82b and passes through the center O of the turning center portion 86. It is preferable that the outer lever 82 be formed such that the angle a is larger than 135 degrees. When the angle a between the lever part 82a and the hook part 82b is thus larger than 90 degrees, the position of the center of gravity of the outer lever 82 is set close to the turning center portion 86 that is the center of turning of the outer lever 82. As a result, the outer lever 82 is less likely to shake, and retaining the outer lever 82 in position requires a smaller retaining force. The coil spring 84 is required to exert a smaller retaining force accordingly.

The one end of the coil spring 84 is connected to the hook part 82b of the outer lever 82. The coil spring 84 is set between the retaining member 80 and the outer lever 82 so as to exert a retaining force for restraining the outer lever 82 from shaking during travel of the vehicle when the outer lever 82 is not being manually operated by the driver.

Here, the coil spring 84 is mounted between the outer lever 82 and the retaining member 80 so as to exert a force (retaining force) in the direction of a tangent to a turning locus of the hook part 82b of the outer lever 82 when the outer lever 82 is not being manually operated by the driver. The turning locus of the hook part 82b of the outer lever 82 is a circle centered at the turning center portion 86, and therefore a tangent T to the turning locus of the hook part 82b of the outer lever 82 is a straight line perpendicular to the second straight line L2. The second straight line L2 is a straight line that is parallel to the longitudinal direction of the hook part 82b and passes through the center O of the turning center portion 86. Therefore, the coil spring 84 is mounted so as to exert a force in a direction perpendicular to the second straight line L2, i.e., parallel to the tangent T, when the outer lever 82 is not being manually operated. In other words, the coil spring 84 is mounted such that the longitudinal direction thereof is parallel to the tangent T when the outer lever 82 is not being manually operated.

When the coil spring 84 is thus mounted so as to exert a force in the direction of the tangent to the turning locus of the hook part 82b of the outer lever 82, the retaining force exerted to restrain the outer lever 82 from shaking can be enhanced and the reliability of the manual release mechanism 74 can thereby also be enhanced.

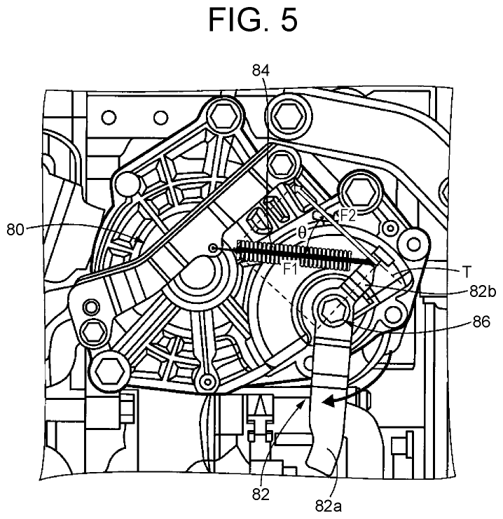

Next, an action of switching the activation state of the parking lock device 40 by operating the manual release mechanism 74 by manual operation of the driver will be described. FIG. 4 shows a relation between forces acting on the outer lever 82 before the manual release mechanism 74 is manually operated, and FIG. 5 shows a relation between the forces acting on the outer lever 82 when the manual release mechanism 74 is manually operated. In FIG. 4 and FIG. 5, the black arrow represents a retaining force F1 exerted by the coil spring 84, and the white arrow represents an operating force F2 required to turn the outer lever 82.

As shown in FIG. 4, before the outer lever 82 is manually operated, the retaining force F1 of the coil spring 84 and the operating force F2 act in the same direction and have the same magnitude. This is because the retaining force F1 acts as the operating force F2 due to the coil spring 84 being mounted so as to exert a force in the direction of the tangent to the turning locus of the hook part 82b of the outer lever 82. Thus, a large retaining force F1 can be produced when the outer lever 82 is not being manually operated.

To manually operate the manual release mechanism 74, the lever part 82a of the outer lever 82 is turned in a clockwise direction as indicated by the arrow in FIG. 5. In this case, as the outer lever 82 is turned in the clockwise direction, an angle θ formed between the retaining force F1 and the operating force F2 increases. The angle θ is, in other words, an angle corresponding to an angle formed by the intersection of a centerline of the coil spring 84 in the longitudinal direction (corresponding to the direction of the retaining force F1) and the tangent T to the turning locus of the hook part 82b of the outer lever 82 (corresponding to the direction of the operating force F2).

When the outer lever 82 is turned, the coil spring 84 is pulled and the retaining force F1 increases. On the other hand, the operating force F2 is calculated by F1×cos θ and cos θ decreases as the angle θ increases. Therefore, although the retaining force F1 increases as the outer lever 82 is turned, the amount of increase in the operating force F2 is reduced. Since the amount of increase in the operating force F2 is thus reduced during a transition period of turning the outer lever 82, burden on the driver during a transition period of turning the outer lever 82 is reduced.

As has been described above, in this embodiment, since the coil spring 84 is mounted between the outer lever 82 and the retaining member 80 so as to exert a force in the direction of the tangent to the turning locus of the outer lever 82, the outer lever 82 is retained by the coil spring 84 with a greater retaining force and restrained from shaking during travel of the vehicle. Thus, generation of noise due to shaking of the outer lever 82 and degradation of the durability of the outer lever can be mitigated. When the outer lever 82 is manually operated, the angle θ formed between the tangent T to the turning locus of the outer lever 82 and the straight line parallel to the direction in which the coil spring 84 exerts a force increases as the outer lever 82 is turned, so that the amount of increase in the operating force F2 required to turn the outer lever 82 is reduced.

In this embodiment, the outer lever 82 is formed such that the angle θ formed by the intersection of the first straight line L1 that is parallel to the longitudinal direction of the lever part 82a and passes through the center O of the turning center portion 86 and the second straight line L2 that is parallel to the longitudinal direction of the hook part 82b and passes through the center θ of the turning center portion 86 is larger than 90 degrees. Thus, the center of gravity of the outer lever 82 is set close to the turning center portion 86 of the outer lever 82. As a result, the outer lever 82 is less likely to shake, and restraining the outer lever 82 from shaking requires a smaller retaining force F1. Since the hook part 82b is provided so as to be located above the turning center portion 86 of the outer lever 82 in the vertical direction in the state of the manual release mechanism 74 being installed in the vehicle, water and mud are less likely to get on the coil spring 84 during travel of the vehicle.

While the embodiment of the present disclosure has been described in detail above based on the drawings, the present disclosure can also be implemented in other forms.

For example, in the above embodiment, the manual release mechanism 74 is applied to the hybrid vehicle having the engine 12 and the second motor MG2 as drive power sources, but the present disclosure is not necessarily limited to this application. The present disclosure can be suitably applied to any vehicles that are equipped with a parking lock device that can switch the travel range of the vehicle between the P-range and the non-P-range.

In the above embodiment, the outer lever 82 is formed so as to be bent at the turning center portion 86. However, the outer lever 82 does not necessarily need to be bent and may instead have a straight linear shape.

In the above embodiment, the outer lever 82 and the retaining member 80 are connected to each other through the coil spring 84. However, the elastic member of the present disclosure is not necessarily limited to the coil spring 84, and any member that can exert an elastic force can be suitably adopted.

In the above embodiment, the coil spring 84 is disposed such that the longitudinal direction thereof is parallel to the tangent T to the turning locus of the hook part 82b when the outer lever 82 is not being manually operated. However, the coil spring 84 may be disposed with the longitudinal direction thereof shifted from the tangent T within such a range that the coil spring 84 exerts a force in the direction of the tangent to the turning locus of the hook part 82b of the outer lever 82.

The form of the parking lock device 40 of the above embodiment is one example, and any parking lock device that is configured to be able to switch between the parking lock state and the non-parking lock state through an actuator can be suitably adopted.

The above embodiment is merely an example, and the present disclosure can be implemented in other forms incorporating various changes and improvements based on the knowledge of those skilled in the art.

What is clamed is:

1. A manual release mechanism for a vehicle parking lock device, the parking lock device including:
a gear mechanically coupled to a driving wheel;
a meshing tooth capable of meshing with the gear; and
an actuator configured to switch between a parking lock state where the meshing tooth and the gear are in mesh and a non-parking lock state where the meshing tooth and the gear are out of mesh, the parking lock device being configured to be manually operated by a driver to switch between the parking lock state and the non-parking lock state through the actuator, the manual release mechanism comprising:
an outer lever configured to be turned by manual operation of the driver to switch an activation state of the parking lock device;
an elastic member of which one end is mounted on the outer lever; and
a retaining member on which the other end of the elastic member is mounted and which is configured to retain the outer lever in a turning position through the elastic member, wherein the elastic member is mounted between the outer lever and the retaining member so as to exert a force in a direction of a tangent to a turning locus of the outer lever when the outer lever is not manually operated by the driver.

2. The manual release mechanism according to claim 1, wherein:
the outer lever is provided in an elongated shape and is configured to be able to turn around a turning center portion that is provided at a predetermined position in the outer lever in a longitudinal direction of the outer lever;
the outer lever includes a lever part that is manually operated by the driver and a hook part on which the one end of the elastic member is mounted, with the turning center portion of the outer lever located on a border between the lever part and the hook part; and
the outer lever is provided such that an angle formed by intersection of a first straight line and a second straight line is larger than 90 degrees, the first straight line being parallel to a longitudinal direction of the lever part and passes through a center of the turning center portion, and the second straight line being parallel to a longitudinal direction of the hook part and passes through the center of the turning center portion.

3. The manual release mechanism according to claim 2, further comprising a shaft interposed between the actuator and the meshing tooth, wherein the turning center portion is mechanically coupled to the shaft.

4. The manual release mechanism according to claim 2, wherein the hook part is provided so as to be located above the turning center portion of the outer lever in a vertical direction in a state of the manual release mechanism being installed in a vehicle.

5. The manual release mechanism according to claim 2, wherein the lever part is provided so as to be located below the turning center portion of the outer lever in a vertical direction in a state of the manual release mechanism being installed in a vehicle.
